(19) United States
(12) Patent Application Publication
(10) Pub. No.: US 2010/0174829 A1
(43) Pub. Date: Jul. 8, 2010

(54) APPARATUS FOR TO PROVIDE CONTENT TO AND QUERY A REVERSE DOMAIN NAME SYSTEM SERVER

(75) Inventor: DEAN DRAKO, LOS ALTOS, CA (US)

Correspondence Address: PATENTRY, P.O. BOX 151616, SAN RAFAEL, CA, 94915-1616, US

(73) Assignee: BARRACUDA NETWORKS, INC, CAMPBELL, CA (US)

(21) Appl. No.: 12/348,917

(22) Filed: Jan. 6, 2009

(51) Int. Cl. G06F 15/16

(52) U.S. Cl. 709/245

(57) ABSTRACT

An apparatus is disclosed for to provide content to and query a reverse domain name system (DNS) server without depending on the kindness of domain name system registrars, registrants. DNS replies are observed by firewalls or filters, analyzed, and transmitted to a reverse domain name system server. An embodiment of the present invention can be within a DNS server or SMTP server.

A co-pending application 12/167134 discloses sending information as a DNS query.

### BACKGROUND

Hostnames are user-friendly human readable mnemonics for computers so that a user can remember a word rather than an IP address in dot-decimal notation for a hexadecimal number. In IPv4, numerals, are delimited by full stops. But, several users can share a host and refer to it by different names and each register a different domain name for the same host. A specific computer visible on the Internet may have many hostnames and be registered with many domain names. Customers of large Internet Service Providers (ISPs) commonly share a single high performance computer.

In many cases contact is made from one IP address to another IP address on the Internet. The receiving host often would like more information about the contacting host in order to make decisions about how to handle the connection or request. For security and other applications, it is desirable to know which domain names are served by or registered to a specific IP address.

However, just because a host has forward DNS from name to address does not always mean that it has a reverse DNS address from address to name. Some sites do, and many do not, or do not have domain names which can be easily located. Some sites may even attempt to hide their domain name for whatever reason, and may only identify their website or mail server using its IP address. Additionally, conventional DNS methodology will reveal only one domain name per IP address, whereas there may be many names associated with one IP address especially where spammers are concerned.

It is generally known among those skilled in the art that while PTR records are defined in the literature known as RFCs, not every IP address has accurate or useful PTR records. There are few penalties if a PTR record is not accurate or even does not exist.

Therefore, as can be appreciated by those persons utilizing the Internet in any way, there exists an important need, and a long overdue solution, for a reliable reverse DNS lookup method and system to identify all, or substantially all, hostnames associated with an IP address. There also exists an important need for such a reliable reverse DNS method and system to perform such important diverse tasks as, inter alia, diagnostics, security functions such as to trace hackers and to prevent spamming and various other authentication functions employing dual lookup, IP-to-name and name-to-IP mapping.

What is needed is an apparatus for providing content to a reverse domain name system server which operates independently of DNS registrars and registrants. One can appreciate that a reliable reverse DNS resolver which is not dependent on voluntary maintenance of PTR records could also be useful for billing, control and other applications.

### SUMMARY OF THE INVENTION

The present invention includes an apparatus which observes and forwards authoritative answers to DNS queries which contain a domain name and an IP address to a reverse DNS server. In an embodiment, the present invention formats a query name by combining a domain name and an IP. In an embodiment, the present invention stores a first argument and a second argument comprising domain names and IP address, and formats at least one PTR field with a domain name, formats a NAME field with an IP address, and transmits a DNS reply to a reverse DNS server.

### BRIEF DESCRIPTION OF DRAWINGS OF EMBODIMENTS

The foregoing and other aspects of these teachings are made more evident in the following Detailed Description of the Preferred Embodiments, when read in conjunction with the attached Drawing Figures, wherein:

FIG. 1 is a block diagram of a data processor suitable for an embodiment;

FIG. 2 is a block diagram of a network in which the apparatus operates;

FIG. 3 is a block diagram of an embodiment of the apparatus;

FIG. 4 is a block diagram of an embodiment of the apparatus;

FIG. 5 is a block diagram of an embodiment of the apparatus; and

FIG. 6 is a flow chart of an embodiment of the system.

### DETAILED DISCLOSURE OF EMBODIMENTS OF THE INVENTION

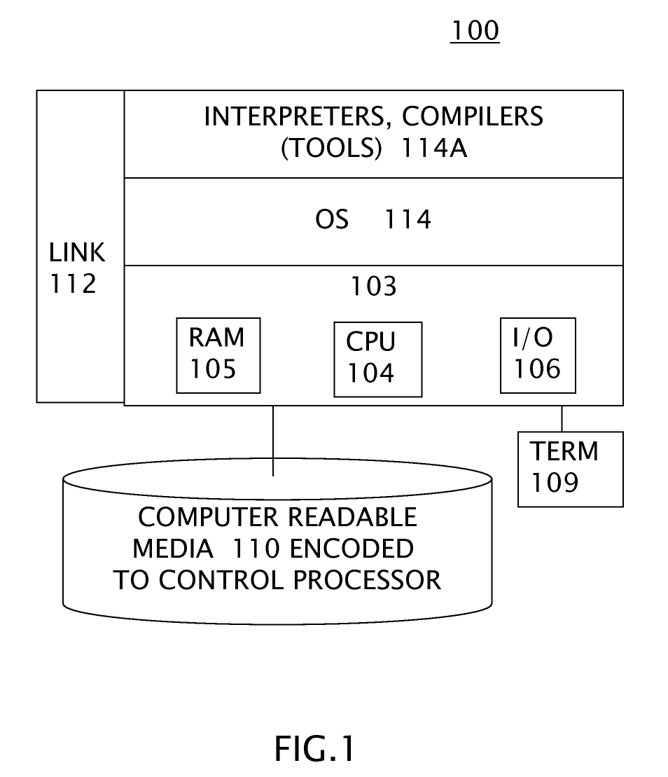

A non-limiting exemplary embodiment of the inventive apparatus is a processor controlled by computer executable instructions encoded on an attached computer readable media. Disclosure of circuits in the apparatus below include a software program product controlling the processor of a firewall, a web filter, a domain name server, and other network appliances without limitation. A computer system is illustrated in FIG. 1 suitable for use as a platform for methods or a component of the inventive apparatus.

A non-limiting exemplary embodiment of the inventive apparatus is a dns log reading circuit coupled to a dns server, the dns log reading circuit controlled by software to read a dns log file, to extract at least one record pair comprising a domain name and its corresponding IP address, and to transmit the pair to a central server.

A non-limiting exemplary embodiment includes a dns log reading circuit controlled by software to read a dns log file, to extract at least one record triplet comprising a domain name, its MX host, and a corresponding IP address of its MX host, and to transmit the record triplet to a central server.

A non-limiting exemplary embodiment includes an apparatus comprising
an observer circuit to observe domain name system (DNS) reply packets coupled to a link circuit,
the observer circuit coupled to a DNS reply analysis circuit to analyze DNS reply packets,
the analysis circuit coupled to a store circuit, and
a store circuit to store reverse DNS data
   wherein the analysis circuit controls the store circuit to store reverse DNS data if the analysis circuit determines a packet is a reply, is an authoritative answer and contains any reverse DNS data.

In an embodiment, reverse DNS data comprises at least two records of a record triplet comprising a domain name, its MX mail server, and an IP address associated with the MX mail server.

In an embodiment, reverse DNS data comprises a record pair comprising a domain name, and an IP address associated with its host IP address.

In an embodiment the inventive apparatus also has a transmitter circuit to transmit reverse DNS data to a central server wherein the transmitter circuit is controlled by software instructions to transmit a file containing reverse DNS data accumulated over a certain period.

In an embodiment the inventive apparatus also has a transmitter circuit to transmit reverse DNS data to a central server wherein the transmitter circuit is controlled by software instructions to transmit a certain maximum quantity of reverse DNS data.

In an embodiment the inventive apparatus also has a transmitter circuit to transmit reverse DNS data to a central server wherein the transmitter circuit is controlled by software instructions to transmit only reverse DNS data which has not been previously uploaded within a certain period.

In an embodiment the inventive apparatus also has a transmitter circuit to transmit reverse DNS data to a central server wherein the transmitter circuit is controlled by software instructions to transmit only reverse DNS data which is not already contained within a database received from the central server.

In an embodiment the inventive apparatus also has a transmitter circuit to transmit reverse DNS data to a central server wherein the transmitter circuit is controlled by software instructions to transmit a reply containing a plurality of PTR records associated with a single IP address.

In an embodiment the inventive apparatus also has a transmitter circuit to transmit reverse DNS data to a central server wherein the transmitter circuit is controlled by software instructions to transmit a duplicate of each instance of reverse DNS data it observes up to a maximum quantity per period.

In an embodiment the inventive apparatus also has a transmitter circuit to transmit reverse DNS data to a central server wherein the transmitter circuit is controlled by software instructions to transmit a duplicate of each instance of reverse DNS data it observes.

An embodiment of the inventive apparatus is disclosed comprised of a domain name system (DNS) packet observer circuit coupled to a network, the reply circuit further coupled to a DNS reply analysis circuit, the DNS reply analysis circuit further coupled to a DNS reply transmitter circuit, and the DNS reply transmitter circuit coupled to the network, wherein the analysis circuits further controls the DNS reply transmitter circuit to send a DNS packet to a reverse DNS server if the DNS reply analysis circuit determines that DNS packet is a reply, is an authoritative answer, and in an embodiment is a type A (but could be MX), contains a domain name in the packet NAME field, and contain an IP address from the packet RR field, whereby the DNS reply transmitter circuit transmits a UDP packet containing the IP address and a domain name from the apparatus to a reverse DNS server coupled to the network.

To avoid network congestion and unnecessary duplication, each of many instances of the apparatus distributed across the Internet may be restricted to only transmit a packet (in an embodiment in UDP format) if the IP address is within a range of the IP address of the apparatus itself, the range defined by a bitmask received from a central server.

An embodiment of the inventive apparatus is disclosed comprised of a domain name system (DNS) packet observer circuit coupled to a network, the reply circuit further coupled to a DNS reply analysis circuit, the DNS reply analysis circuit further coupled to a DNS QNAME setting circuit, the DNS QNAME setting circuit coupled to a DNS query transmitter circuit, and the DNS query transmitter circuit coupled to the network, wherein the DNS reply analysis circuit controls the DNS QNAME setting circuit to append a NAME comprising a first argument to a RECORD comprising a second argument if the DNS reply analysis circuit determines that DNS packet is a reply, is an authoritative answer, and in an embodiment is a type A, wherein a first argument is a domain name from the packet NAME field, and a second argument is an IP address from the packet RR field and wherein the DNS query transmitter circuit transmits a UDP or other format packet containing the IP address and the domain name from the apparatus to a reverse DNS server coupled to the network.

To avoid network congestion and to distribute the load on reception of the reverse IP data each of the instances of the apparatus distributed across the Internet may have its DNS query transmitter circuit controlled to transmit a packet to a DNS server associated with a range of the IP address of the apparatus itself, the range defined by a bitmask received from a central server. For example a central server may be configured to only receive packets from apparatus whose IP address begins with 207.

An embodiment of the inventive apparatus is disclosed comprised of a domain name system (DNS) packet observer circuit coupled to a network, the reply circuit further coupled to a DNS reply analysis circuit, the DNS reply analysis circuit further coupled to an argument store, the argument store coupled to a DNS NAME and DNS PTR setting circuit, the DNS NAME and DNS PTR setting circuit coupled to a DNS reply transmitter circuit, and the DNS reply transmitter circuit coupled to the network, wherein the argument store comprises computer readable media encoded with a first argument and a second argument if the DNS reply analysis circuit determines that DNS packet is a reply, is an authoritative answer, wherein a first argument is a domain name from the packet NAME field, and a second argument is an IP address from the packet RR field and

wherein the DNS NAME setting circuit encodes a second argument comprising a selected IP address as a DNS NAME field and the DNS PTR setting circuit encodes at least one first argument comprising a domain name as a DNS PTR field and wherein the DNS reply transmitter circuit transmits a UDP packet containing the selected IP address and at least one domain name from the apparatus to a reverse DNS server coupled to the network.

To avoid unnecessary traffic and increase the density of information the apparatus may have a further constraint downloaded from the central server to control the DNS reply transmitter circuit to transmit a packet only if a plurality of DNS PTR fields associated with a single IP address are available to be transmitted.

An embodiment of the inventive method is disclosed for building a reverse IP database comprising the steps selected from the group consisting of: (a) receiving dns replies associated with one or more domain names which provides an IP address; (b) performing reverse DNS on said IP address in associated root servers and name servers to obtain host names; (c) crawling websites associated with said host names and seeking new hosts on known websites in different top level domains (TLDs); (d) indexing all new host names found; (e) resolving the associated IP address with each host name; (f) repeating any of steps (b), (c), (d), and (e) one or more times.

The inventive method further includes the step of storing DNS entries while logging an entries association with a host name. The inventive method further includes receiving a list of domain names from a central server whereby a plurality of search systems are assigned different portions of the domain name space. A large number of distributed processors may thus work in parallel. The inventive method further includes generating a result of the search and uploading the result to a central server. The inventive method further includes a step of searching MX records, IP addresses therefrom, and performing reverse DNS, and optionally forward DNS, thereon. The inventive method further includes generating a result of the mail server search and uploading the result to a central server.

A tangible beneficial result of performing the steps of the invention supports conducting a business comprising activities selected from the group consisting of manufacturing, having manufactured, advertising, offering for sale, selling, distributing and licensing a spam email and web filtering subscription service checking a reputation server based on the present invention.

The present invention further comprises a computer implemented method comprising controlling a processor to execute instructions to perform the following steps: receiving an email from an smtp client, wherein smtp is simple mail transfer protocol; reading a source IP address from a TCP/IP header of said email; reading a domain name from a MAIL FROM command of said email; transmitting a reverse IP query to a reverse domain name system server comprising said source IP address; receiving a response from said reverse domain name system server comprising at least one co-hosted domain name; and determining to forward or delete said email by comparing said co-hosted domain name with a list of known spammers.

FIG. 1 shows a block diagram of a typical computing system 100 where the preferred embodiment of this invention can be practiced. The computer system 100 includes a computer platform having a hardware unit 103, that implements the methods disclosed below. The hardware unit 103 typically includes one or more central processing units (CPUs) 104, a memory 105 that may include a random access memory (RAM), and an input/output (I/O) interface 106. Various peripheral components may be connected to the computer platform. Typically provided peripheral components include a terminal 109, an external data storage device (e.g. tape or disk) 110 where the data used by the preferred embodiment is stored. A link 112 may also be included to connect the system 100 to one or more other similar computer systems. The link 112 may also provide access to the global Internet. An operating system (OS) 114 coordinates the operation of the various components of the computer system 100, and is also responsible for managing various objects and files, and for recording certain information regarding same. Lying above the OS 114 is a software tools layer 114A containing, for example, compilers, interpreters and other software tools. The interpreters, compilers and other tools in the layer 114A run above the operating system and enable the execution of programs using the methods known to the art.

One suitable and non-limiting example of computer system 100 is the Barracuda(TM) Spam Firewall (trademark of Barracuda Networks, Inc.) or a PC running Linux. An example of a suitable CPU is a Pentium(TM) III processor (trademark of the Intel Corporation); examples of an operating systems is GNU/Linux; examples of an interpreter and a compiler are a Perl interpreter and a C++ compiler. Those skilled in the art will realize that one could substitute other examples of computing systems, processors, operating systems and tools for those mentioned above. As such, the teachings of this invention are not to be construed to be limited in any way to the specific architecture and components depicted in FIG. 1.

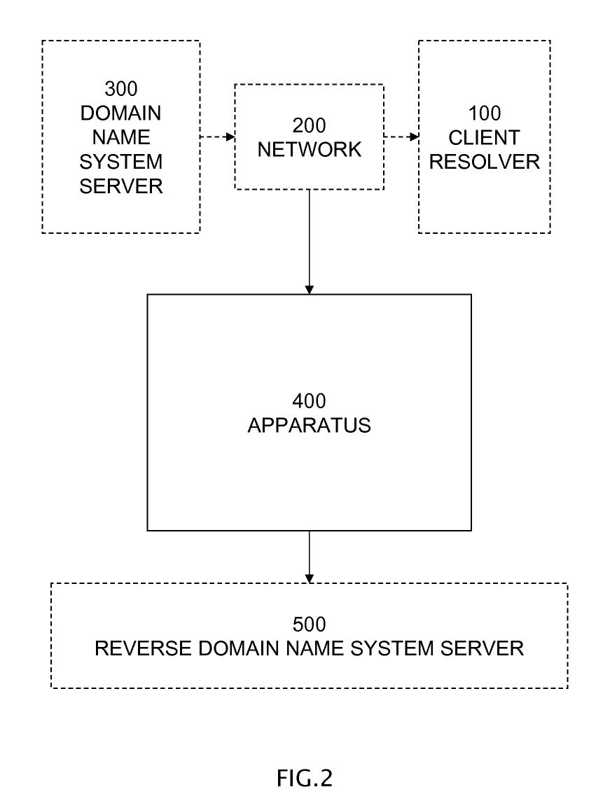

Referring now to FIG. 2 a block diagram shows the apparatus of the present invention 400, in an embodiment a processor controlled by instructions encoded on computer readable media, coupled to a network 200 and further coupled to a reverse domain name system server 500, in an embodiment through a public wide area network. The apparatus observes responses on the network sent from a DNS(domain name system) server 300 to a client resolver 100. The apparatus operates according to the method described below and comprises circuits in the claims below and the following disclosure. An exemplary non-limiting embodiment of circuit means is a processor controlled by instructions stored on computer readable media.

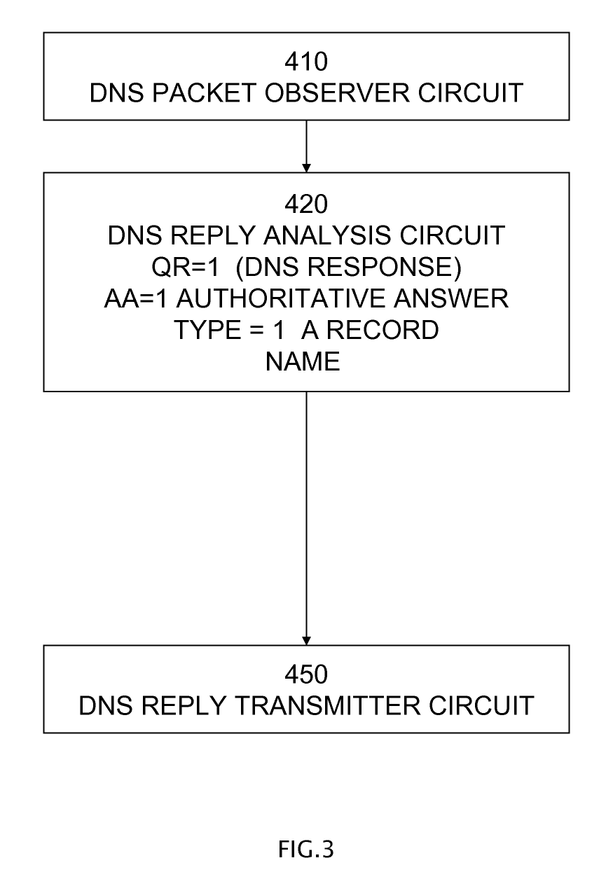

Referring now to FIG. 3 a block diagram shows a DNS (domain name system) packet observer circuit 410, in an embodiment a processor controlled by instructions, which receives a UDP packet which contains a DNS reply (QR=1) from an authoritative server (AA=1). The contents of the packet are provided to a DNS reply analysis circuit 420 which checks that it is a reply from an authoritative server for a query type A (type=1). The DNS reply is duplicated and sent by a DNS reply transmitter circuit 450 to a reverse domain name system server.

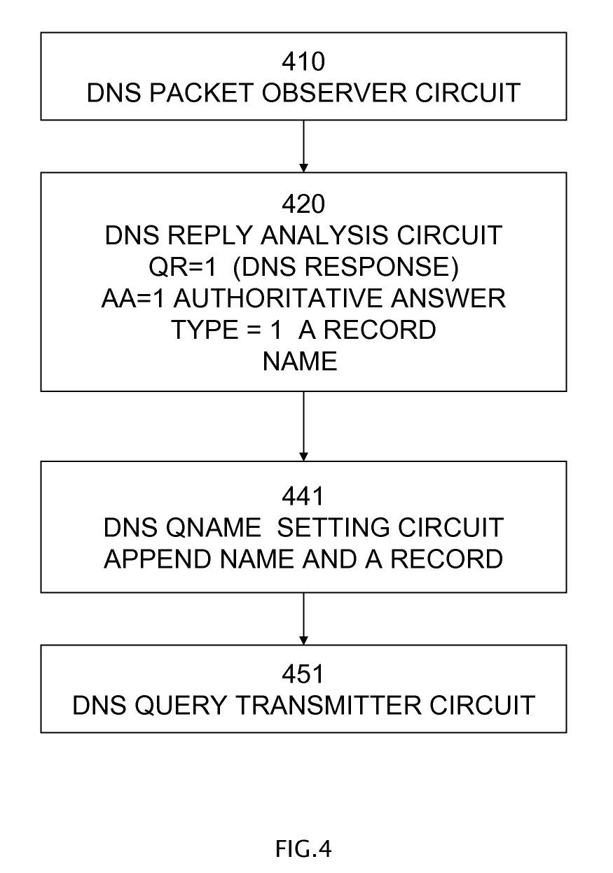

Referring now to FIG. 4 a block diagram shows a DNS (domain name system) packet observer circuit 410, in an embodiment a processor controlled by instructions, which receives a UDP packet which contains a DNS reply (QR=1) from an authoritative server (AA=1). The contents of the packet are provided to a DNS reply analysis circuit 420 which checks that it is a reply from an authoritative server for a query type A (type=1). A DNS QNAME setting circuit appends the value of the field NAME and the value of the field RDATA as argument one and argument two. A DNS query transmitter circuit 451 sends the name and record as arguments in a DNS query to a reverse domain name system server.

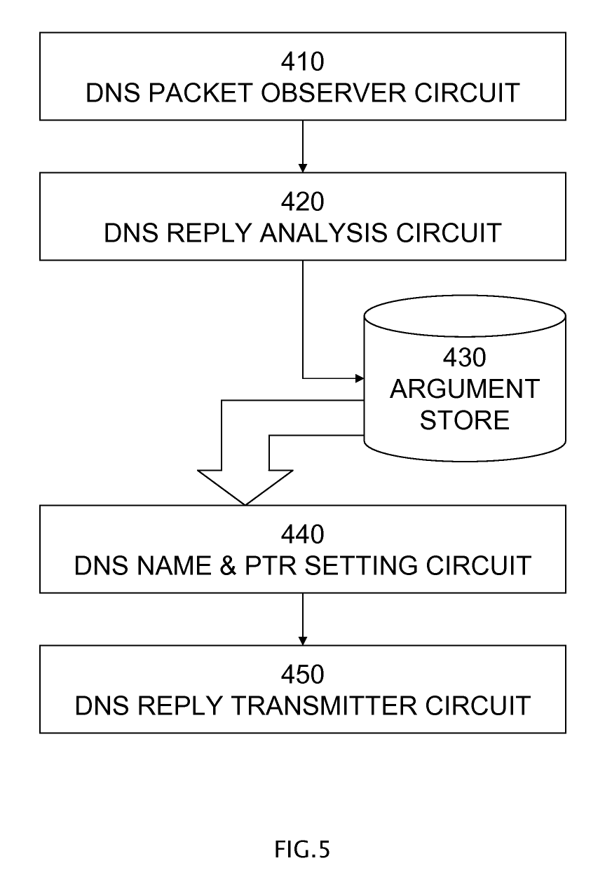

Referring now to FIG. 5 a block diagram shows a DNS (domain name system) packet observer circuit 410, in an embodiment a processor controlled by instructions, which receives a UDP packet which contains a DNS reply (QR=1) from an authoritative server (AA=1). The contents of the packet are provided to a DNS reply analysis circuit 420 which checks that it is a reply from an authoritative server for a query type A (type=1) and stores the value of the field NAME and the value of the field RDATA to computer readable media 430 as argument one and argument two. A DNS name and PTR setting circuit 440 retrieves an IP address from the argument store and at least one domain name from the argument store 430 which provide arguments to be sent by a DNS reply transmitter circuit 450 to a reverse domain name system server.

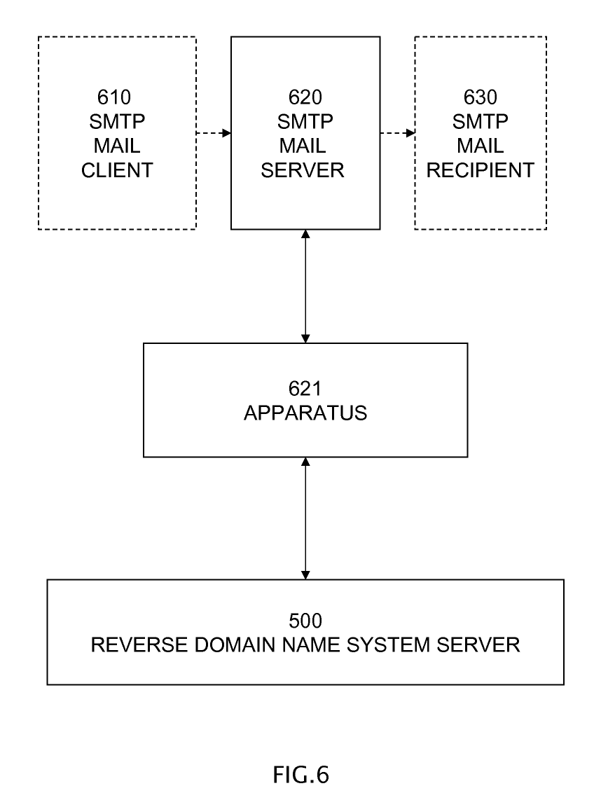

Referring now to FIG. 6, a flowchart shows an SMTP (simple mail transfer protocol) mail server 620 receiving an email from a conventional SMTP mail client 610, intended for an email recipient 630. According to the present invention an apparatus 621, in an embodiment a processor controlled by instructions, receives the source IP address read from the TCP/IP header by the SMTP mail server 620 and, in an embodiment, the domain embedded in the MAIL FROM command transmitted by the SMTP mail client 610. The apparatus sends a reverse DNS (domain name system) query to a reverse domain name system server of the present invention 500 comprising the source IP address from the TCP/IP header and receives in reply at least one domain name. When a plurality of domain names is associated with an IP address, the apparatus determines to forward the email to the recipient or delete it if any of the domain names hosted on that address is associated with a spammer. It is the observation of the inventor that domain names which are easy to register and inexpensive to discard are characteristic of spammers.

The figures and illustrations are provided to convey the breadth of embodiments and are not to considered limitations on the claimed invention.

### Conclusion

The present invention discloses an apparatus for building a database which contains a list of all domain names connected with each IP address. As DNS traffic passes through firewalls and webfilters, authoritative answers to DNS queries are collected.

Such a database can be used for reducing spam by checking an email received from an IP address and purporting to be from a domain. Such a database can be used to double check a browser to verify that its DNS cache has not been poisoned. Such a database can be used to evaluate a domain which is hosted on a server which operates a number of domains.

The present invention is distinguished from conventional reverse domain name systems by not depending on the accurate and timely provision of PTR records to the (dot) arpa system. The present invention is distinguished from conventional reverse domain name systems by providing multiple domain names which are hosted on the same IP address which is not currently implemented. The present invention is distinguished from conventional reverse IP systems by not downloading historical databases from regional authorities and cross referencing or datamining A records and MX records. The present invention is distinguished from conventional reverse IP lookup systems by receiving IP addresses issued by authoritative DNS servers in response to genuine DNS queries from authentic users. Conventional reverse dns lookup provides a single voluntary PTR record.

Significantly, this invention can be embodied in other specific forms without departing from the spirit or essential attributes thereof, and accordingly, reference should be had to the following claims, rather than to the foregoing specification, as indicating the scope of the invention.

What is claimed is:

1. An apparatus comprising a dns log reading circuit coupled to a dns server, the dns log reading circuit controlled by software to read a dns log file, to extract at least one record pair comprising a domain name and its corresponding IP address, and to transmit the pair to a central server.

2. The apparatus of claim 1 further comprising a dns log reading circuit controlled by software to read a dns log file, to extract at least one record triplet comprising a domain name, its MX host, and a corresponding IP address of its MX host, and to transmit the triplet to a central server.

3. An apparatus comprising
an observer circuit to observe domain name system (DNS) reply packets coupled to a link circuit,
the observer circuit coupled to a DNS reply analysis circuit to analyze DNS reply packets,
the analysis circuit coupled to a store circuit,
and a store circuit to store reverse DNS data
wherein the analysis circuit controls the store circuit to store reverse DNS data if the analysis circuit determines a packet is a reply, is an authoritative answer and contains any reverse DNS data.

4. The apparatus of claim 3 wherein reverse DNS data comprises at least two records of a record triplet comprising a domain name, its MX mail server, and an IP address associated with the MX mail server.

5. The apparatus of claim 3 wherein reverse DNS data comprises a record pair comprising a domain name, and an IP address associated with its host IP address.

6. The apparatus of claim 3 further comprising
a transmitter circuit to transmit reverse DNS data to a central server wherein the transmitter circuit is controlled by software instructions to transmit
a file containing reverse DNS data accumulated over a certain period.

7. The apparatus of claim 3 further comprising
a transmitter circuit to transmit reverse DNS data to a central server wherein the transmitter circuit is controlled by software instructions to transmit a certain maximum quantity of reverse DNS data.

8. The apparatus of claim 3 further comprising
a transmitter circuit to transmit reverse DNS data to a central server wherein the transmitter circuit is controlled by software instructions to transmit only reverse DNS data which has not been previously uploaded within a certain period.

9. The apparatus of claim 3 further comprising
a transmitter circuit to transmit reverse DNS data to a central server wherein the transmitter circuit is controlled by software instructions to transmit only reverse DNS data which is not already contained within a database received from the central server.

10. The apparatus of claim 3 further comprising
a transmitter circuit to transmit reverse DNS data to a central server wherein the transmitter circuit is controlled by software instructions to transmit a reply containing a plurality of PTR records associated with a single IP address.

11. The apparatus of claim 3 further comprising
a transmitter circuit to transmit reverse DNS data to a central server wherein the transmitter circuit is controlled by software instructions to transmit a duplicate of each instance of reverse DNS data it observes up to a maximum quantity per period.

12. The apparatus of claim 3 further comprising
a transmitter circuit to transmit reverse DNS data to a central server wherein the transmitter circuit is controlled by software instructions to transmit a duplicate of each instance of reverse DNS data it observes.

13. An apparatus comprising a domain name system (DNS) packet observer circuit coupled to a network, the observer circuit further coupled to a DNS reply analysis circuit, the DNS reply analysis circuit further coupled to a DNS reply transmitter circuit, and the DNS reply transmitter circuit coupled to the network, wherein the analysis circuits further controls the DNS reply transmitter circuit to send a DNS packet to a reverse DNS server if the DNS reply analysis circuit determines that DNS packet is a reply, is an authoritative answer, contains a domain name in the packet NAME field, and contains an IP address from the packet RR field, whereby the DNS reply transmitter circuit transmits a packet containing one of the IP address and a domain name and an MX record and a domain name from the apparatus to a reverse DNS server coupled to the network.

14. The apparatus of claim 13 wherein the DNS reply transmitter circuit only transmits a packet if the IP address is within a range of the IP address of the apparatus itself, the range defined by a bitmask received from a central server.

15. An apparatus comprising a domain name system (DNS) packet observer circuit coupled to a network, the reply circuit further coupled to a DNS reply analysis circuit, the DNS reply analysis circuit further coupled to a DNS QNAME setting circuit, the DNS QNAME setting circuit coupled to a DNS query transmitter circuit, and the DNS query transmitter circuit coupled to the network, wherein the DNS reply analysis circuit controls the DNS QNAME setting circuit to append a NAME comprising a first argument to a RECORD comprising a second argument if the DNS reply analysis circuit determines that DNS packet is a reply, is an authoritative answer, wherein a first argument is a domain name from the packet NAME field, and a second argument is an IP address from the packet RR field
and wherein the DNS query transmitter circuit transmits a UDP packet containing the IP address and the domain name from the apparatus to a reverse DNS server coupled to the network.

16. The apparatus of claim 15 wherein the DNS query transmitter circuit transmits the UDP packet to a DNS server associated with a range of the IP address of the apparatus itself, the range defined by a bitmask received from a central server.

17. An apparatus comprising a domain name system (DNS) packet observer circuit coupled to a network, the reply circuit further coupled to a DNS reply analysis circuit, the DNS reply analysis circuit further coupled to an argument store, the argument store coupled to a DNS NAME and DNS PTR setting circuit, the DNS NAME and DNS PTR setting circuit coupled to a DNS reply transmitter circuit, and the DNS reply transmitter circuit coupled to the network, wherein the argument store comprises computer readable media encoded with a first argument and a second argument if the DNS reply analysis circuit determines that DNS packet is a reply, and is an authoritative answer, wherein a first argument is a domain name from the packet NAME field, and a second argument is an IP address from the packet RR field and
wherein the DNS NAME setting circuit encodes a second argument comprising a selected IP address as a DNS NAME field and the DNS PTR setting circuit encodes at least one first argument comprising a domain name as a DNS PTR field and wherein the DNS reply transmitter circuit transmits a UDP packet containing the selected IP address and at least one domain name from the apparatus to a reverse DNS server coupled to the network.

18. The apparatus of claim 17 wherein the DNS reply transmitter circuit transmits a UDP packet only if a plurality of DNS PTR fields are available to be transmitted.

19. A computer implemented method for building a reverse IP database comprising controlling a processor to execute instructions to perform the steps selected from the group consisting of: (a) receiving dns replies associated with one or more domain names which provides an IP address; (b) performing reverse DNS on said IP address in associated root servers and name servers to obtain host names; (c) crawling websites associated with said host names and seeking new hosts on known websites in different TLDs; (d) indexing all new host names found; (e) resolving the associated IP address with each host name; (f) repeating any of steps (b), (c), (d), and (e) one or more times.

20. The method of claim 19 further comprising the step of storing DNS entries while logging an entries association with a host name.

21. The method of claim 19 further comprising receiving a list of domain names from a central server whereby a plurality of search systems are assigned different portions of the domain name space.

22. The method of claim 19 further comprising generating a result of the search and uploading the result to a central server.

23. The method of claim 19 further comprising a step of searching MX records, IP addresses therefrom, and performing reverse DNS, and optionally forward DNS, thereon.

24. The method of claim 20 further comprising generating a result of the search and uploading the result to a central server.

25. A computer implemented method comprising controlling a processor to execute instructions to perform the following steps: receiving an email from an smtp client, wherein smtp is simple mail transfer protocol; reading a source IP address from a TCP/IP header of said email; reading a domain name from a MAIL FROM command of said email; transmitting a reverse IP query to a reverse domain name system server comprising said source IP address; receiving a response from said reverse domain name system server comprising at least one co-hosted domain name; and determining to forward or delete said email by comparing said co-hosted domain name with a list of known spammers.
